(19) United States
(12) Patent Application Publication
(10) Pub. No.: US 2014/0190915 A1
(43) Pub. Date: Jul. 10, 2014

(54) SADDLE RACK WITH REMOVABLE LEGS

(71) Applicant: Ricky D. McBride, Silo, OK (US)

(72) Inventor: Ricky D. McBride, Silo, OK (US)

(21) Appl. No.: 13/738,891

(22) Filed: Jan. 10, 2013

(51) Int. Cl. B68C 1/00

(52) U.S. Cl. CPC B68C 1/002
USPC 211/85.11

(57) ABSTRACT

A collapsible saddle rack with detachable legs is provided to enable easy transportation and compact storage. The saddle rack comprises an upper portion formed to support at least one saddle wherein the upper portion is collapsible. The saddle rack includes a lower portion comprising plurality of legs removably connected to the upper portion of the saddle rack wherein the lower portion is also collapsible. A connecting mechanism removably attaches the legs to the upper portion wherein the upper portion and lower portion occupy the least space in collapsed configuration. The connecting mechanism is configured to firmly connect the legs to the upper portion to prevent the removal of the legs from the upper portion and to provide stability to the saddle rack. The saddle rack enables easy transportation and compact storage due to easy assembling/disassembling and collapsible functionalities. The saddle rack is light weight, inexpensive and easy to manufacture.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

1. Technical Field

The present invention relates to an improved saddle rack with detachable legs. More particularly, the invention relates to a saddle rack with detachable legs to enable easy transportation and compact storage. The compactness and collapsibility of the present invention also permits shipment in smaller container, thereby providing significant cost savings on shipping.

2. Background Art

A saddle rack is mainly used for hanging saddles when the saddles are not being used. Due to its significantly high costs and utility, a saddle has to be properly cared for, be it a utility saddle, general saddle or saddles used for racing or exhibition horse shows. Accordingly great care is required even when the saddle is not in use which is easily taken care of by portable and foldable saddle racks which can be transported from one place to another.

There are a number of patents/applications for saddle racks with various designs and configurations which provide portability to a saddle rack.

U.S. patent application publication number US20070158285(A1)(Mann) discloses a saddle rack comprised of an upper portion or body upon which the saddle rests, fabricated by plastic mould injection, approximating an equine's back shape and supported by four legs. Bridle and halter may be stored on handles, and baskets provide extra storage space. Numerous embodiments are provided, including embodiments to accommodate either Western or English shaped saddles. Preferably, the body is of webbed or perforated design allowing additional air penetration and ventilation of the underside of a saddle resting on the rack, advantageously providing the saddle a means to dry while being stored. More preferably, racks may be stacked for shipping or display, to save space. Maintenance and cleaning are greatly simplified by durable plastic design. These saddle racks employ detachable legs (configured with upper keyed slides) which are fitted to the upper portion using key-way slot mechanisms.

U.S. Pat. No. 7,168,666 discloses a device having at least two strut assemblies joined together to form a free standing support that is both portable and collapsible. Components may be joined to one another by a flexible cord, and a flexible load bearing web to limit the maximum open position. One embodiment (FIG. 23) depicts use of the support for storing a saddle.

U.S. patent application publication number US2011094984 (A1) discloses a saddle rack system that is an equestrian device that provides for the easy transportation and storage of one or two saddles and additional tack and accessories. A saddle size adjusting feature is available on the main unit and the built-in collapsible second rack that provides suitable support and adapts to any type or size of saddle. This saddle rack is collapsible to form a smaller footprint, can be moved when in either opened or collapsed position, and has the ability to stand independently in the open position on all four wheels, or collapsed by deploying the kickstand. Handles with detachable extensions are incorporated for greater maneuverability. A simple braking system provides greater stability when loading, unloading, or collapsing for storage. A storage container holds all the rack's attachments, and provides personal, lockable storage when the attachments are in use. A feed bucket and a cup/fly spray holder are included.

Wooden saddle stands exist that are very bulky and built as a unitary structure making transportation of the saddle stand impractical. Other bulky saddle stands and saddle stand carts exist, but again present bulkier challenges for storage and shipment.

Prior art standard saddle stands exist that collapse from an open position to a closed position, such as the saddle stands offered by Jefferspet.com; the Pro-Craft Folding Saddle stand sold through statelinetack.com (www. Statelinetack.com/item/pro-craft-folding-saddle-stand/SLT310345/), the Dover brand of folding portable model (which has slightly different base/shelf made of a metal rack) sold via doversaddlery.com (www. Doversaddlery.com/portable-saddle-stand/p/X1-2702/), and the Saddle Stand depicted in U.S. Design Pat. No. D208155 (Swanson). These prior art stands can collapse slightly about the axis created by the bolts to permit some compactness, but they remain in full height. Another prior art saddle stand provided by horseloverz.com (www.horseloverz.com/English/727780-Saddle-Stand.html) employs a pre-formed, non-collapsible upper section with detachable legs.

Therefore, there still exists a need for a very compact, collapsible saddle rack to provide ease of transport, shipment and storage, and ease of assembly, disassembly and reassembly.

### BRIEF SUMMARY OF THE INVENTION

Accordingly, one of the objects of the present invention is to provide an improved collapsible saddle rack having detachable legs to enable easy transportation and compact storage.

Another object of the present invention is to provide a saddle rack which is easy to assemble and disassemble.

Another object of the present invention is to provide a saddle rack wherein the legs are not completely disassembled after detaching from the main assembly.

Another object of the present invention is to provide a saddle rack which is light weight, inexpensive and easy to manufacture.

To achieve these and other objectives, the present invention provides a collapsible saddle rack with detachable legs to enable easy transportation and compact storage. In one embodiment, the saddle rack comprises an upper portion formed to support at least one saddle wherein the upper portion is collapsible. The saddle rack includes a lower portion further comprising plurality of legs removably connected to the upper portion of the saddle rack wherein the lower portion is collapsible. A connecting means removably attaches the legs to the upper portion wherein the upper portion and lower portion occupy the least space in collapsed configuration. The connecting means is configured to firmly connect the legs to the upper portion to prevent the removal of the legs from the upper portion and to provide stability to the saddle rack.

In one embodiment, the lower portion further includes a basket attached at the lower end of the lower portion to preventing the disassembling of the legs upon being detached from the upper portion. The basket may be made of a soft material to enable folding of the lower portion easily while being collapsed.

The saddle rack according to the invention enables easy transportation and compact storage due to easy assembling/disassembling and collapsible functionalities. Since the legs are not completely disassembled while being detached from the upper portion, it becomes easier to re-assemble and manage the whole assembly. The saddle rack according to the present invention in which is light weight, inexpensive and easy to manufacture.

In another embodiment, there is disclosed a saddle rack comprising: (a) an upper portion formed to support at least one saddle wherein the upper portion is collapsible; (b) a lower portion comprising plurality of legs removably connected to the upper portion of the saddle rack wherein the lower portion is collapsible; and (c) a connector for removably attaching the legs to the upper portion, wherein the upper portion and lower portion occupy the least space in collapsed configuration. The connector may be configured to firmly connect the legs to the upper portion to prevent the removal of the legs from the upper portion and to provide stability to the saddle rack. The lower portion of the saddle rack may further include a basket attached at the lower end of the lower portion to preventing the disassembling of the legs upon being detached from the upper portion. The basket may be constructed of a soft material to enable folding of the lower portion easily while being collapsed.

In another embodiment, there is disclosed a collapsible saddle rack comprising: an upper portion formed to support at least one saddle wherein the upper portion is collapsible, the upper portion comprising a plurality of inverted U-shaped tubes each having a substantially horizontal base section and two opposed, downwardly extending side members, each side member having an end; a collapsible lower portion removably connected to the upper portion of the saddle rack, the lower portion comprising a plurality of legs each having a bottom end for contacting a desired surface and a top end removably connected to the respective end of each of said side members; and a connector for removably attaching the legs to the upper portion, wherein the upper portion and lower portion occupy the least space in collapsed configuration. The connector may further comprise: extension members on the ends of the downwardly extending side members, and receiving members in the top ends of each of the plurality of legs for receiving said extension members. The connector may further comprise: a spring loaded push-pin located on each of the extension members, an aperture located in the receiving members for receiving the push-pin so that the extension member is locked into place within the receiving member.

In one embodiment, the inverted U-shaped tubes in the upper member are configured to provide an outer profile suitable for receiving a Western style saddle (or other style saddle) when the saddle rack is in an open (not collapsed) position.

Preferably, the plurality of inverted U-shaped tubes are pivotally connected to each other proximate their ends.

In one embodiment, the plurality of inverted U-shaped tubes further comprises a central inverted U-shaped tube flanked on either side by two outside U-shaped tubes, the ends of the central tube and the two outside tubes being joined together with a horizontally axially-oriented bolt to permit the outside tubes to rotate inwardly or outwardly about said axis relative to the central tube or each other.

In another embodiment, the collapsible lower portion comprises individual leg members that are removably attachable to a corresponding end of the inverted U-shaped tubes of the upper section.

In another embodiment, the collapsible lower portion comprises two U-shaped members each comprising a lower base section connecting two opposed legs that are aligned substantially parallel to each other and substantially perpendicular to the base section, each opposed leg having an upper end for removably connecting to a corresponding one of the ends of upper section outside tubes, and a lower end for engaging a surface supporting the saddle stand.

In various embodiments, a plurality of flexible straps are mounted between the based section of each of the two U-shaped members to form a shelf.

Additionally, a flexible strap may be employed connecting between the central inverted U-shaped tube and the two outside U-shaped tubes to provide a physical stop to prevent further opening of the saddle stand upper portion about the axially-oriented bolt.

It is to be understood that both the foregoing general description and the following details description are exemplary and explanatory and are intended to provide further explanation of the invention as claimed.

### BRIEF DESCRIPTION OF THE SEVERAL VIEWS OF THE DRAWINGS

FIG. 1A is a front perspective view of a collapsible saddle rack in an open and unfolded configuration, according to one embodiment of the invention.

FIG. 1B is a perspective view of the collapsible saddle rack of FIG. 1A shown with the legs detached, according to one embodiment of the invention.

FIG. 2 is a rear perspective view of the collapsible saddle rack of FIG. 1A.

FIG. 3 is a right perspective view of the collapsible saddle rack of FIG. 1A.

FIG. 4A is an enlarged, partial front right side view of the collapsible saddle rack of FIG. 1A.

FIG. 4B is an enlarged, partial front right side view of the collapsible saddle rack of FIG. 1A.

FIG. 5A is an enlarged, partial rear right side view of the collapsible saddle rack of FIG. 1A illustrating the legs in a detached position.

FIG. 5B is the view of FIG. 5A illustrating the legs in an attached position.

FIG. 6A is a rear perspective view of the collapsible saddle rack of FIG. 1A.

FIG. 6B is an enlarged, partial view of the collapsible saddle rack of FIG. 6A.

FIG. 7 is an underside perspective view of the saddle rack of FIG. 1A.

FIG. 8A is a left side view of the collapsible saddle rack of FIG. 1A shown in a closed and folded configuration, according to one embodiment of the invention.

FIG. 8B is an enlarged, partial front left side view of the collapsible saddle rack of FIG. 8A.

FIG. 8C is an enlarged, partial front left side view of the collapsible saddle rack of FIG. 8B.

FIGS. 9A and 9B illustrate the collapsible saddle stand of FIG. 8A with the legs shown in a detached position.

FIG. 10 is a perspective view of the detached upper portion of the collapsible saddle rack of FIG. 1A, according to one embodiment of the invention.

FIG. 11 is a perspective view of the detached lower portion of the collapsible saddle rack of FIG. 1A, according to one embodiment of the invention.

FIGS. 12A-12D show an enlarged, partial rear left side view of the collapsible saddle rack of FIG. 1A illustrating assembly of the legs to the upper section of the saddle rack.

FIGS. 13-14 show a top view of the collapsed upper portion of the collapsible saddle rack placed above the collapsed legs portion in a compact configuration for shipment or storage according to one embodiment of the invention.

### DETAILED DESCRIPTION OF THE INVENTION

Reference is now made to the drawings which depict preferred embodiments of the present invention, but are not drawn to scale.

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

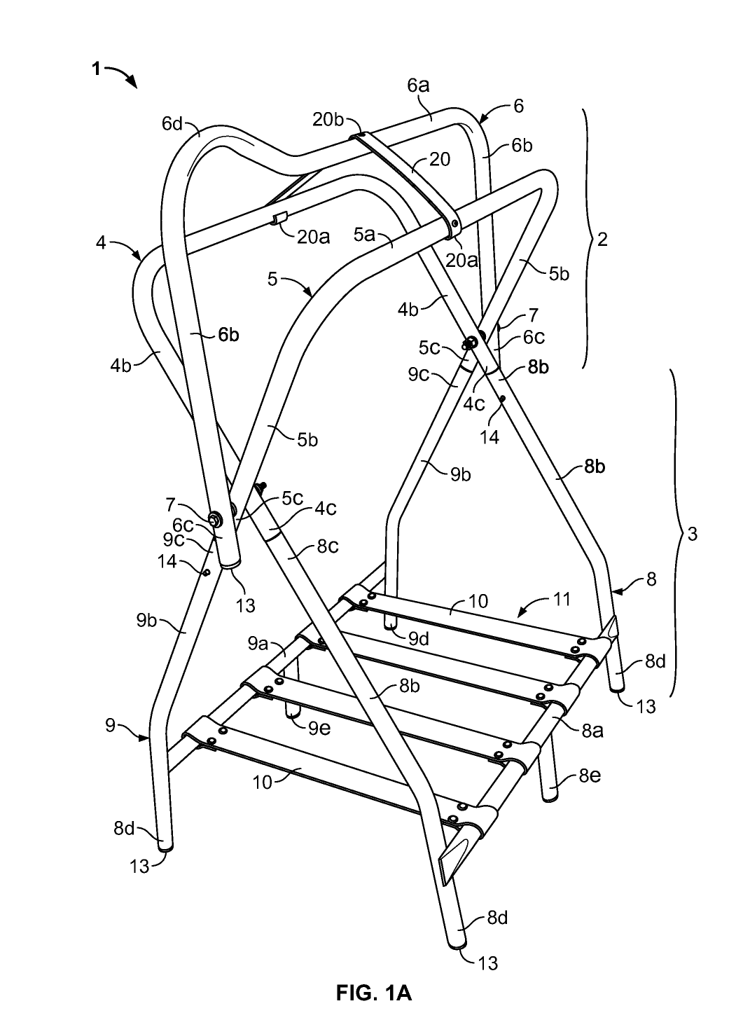

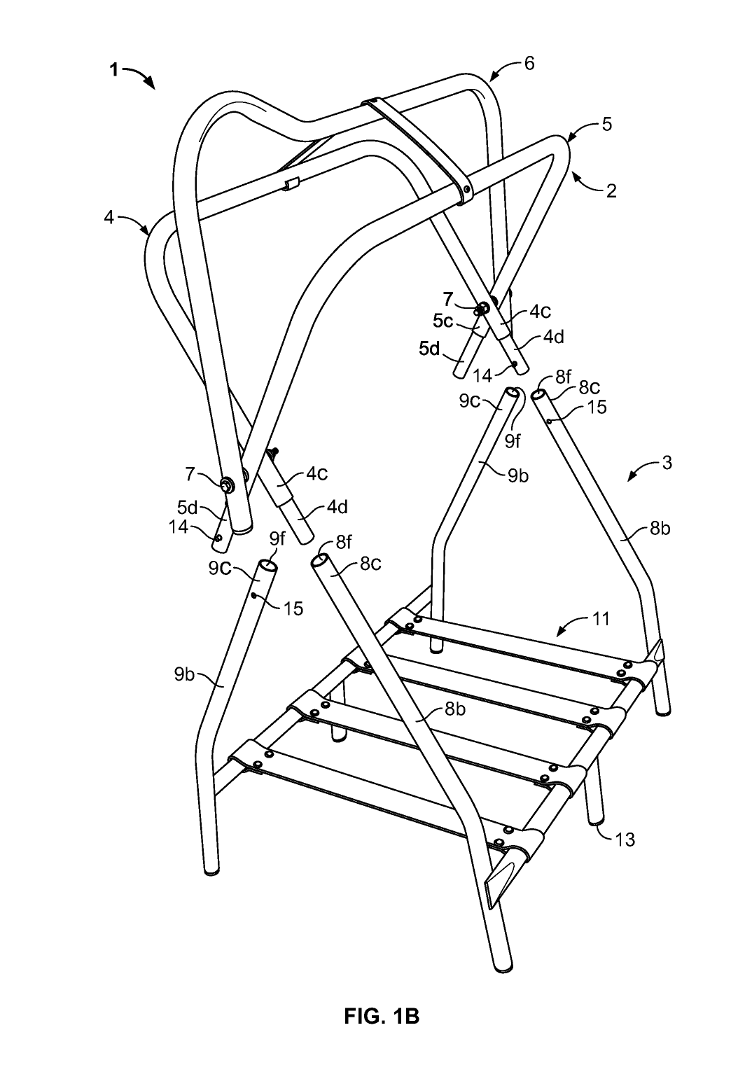

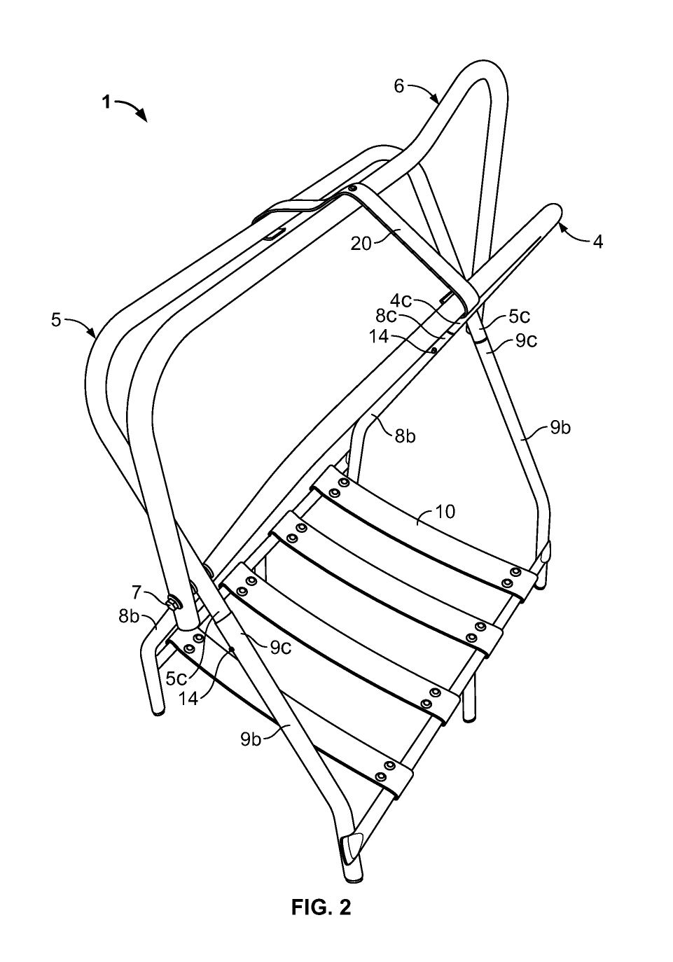

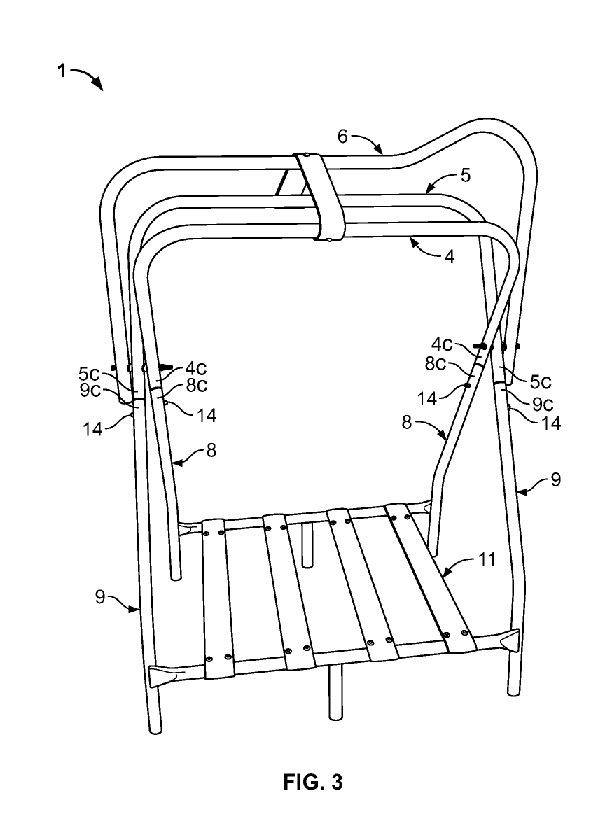

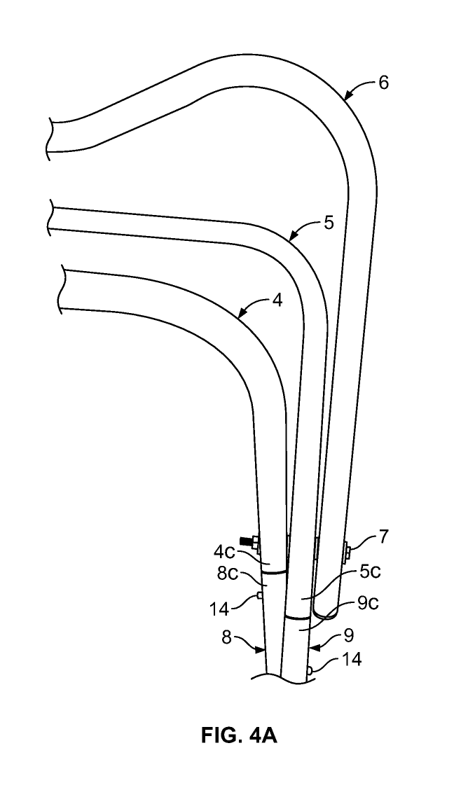

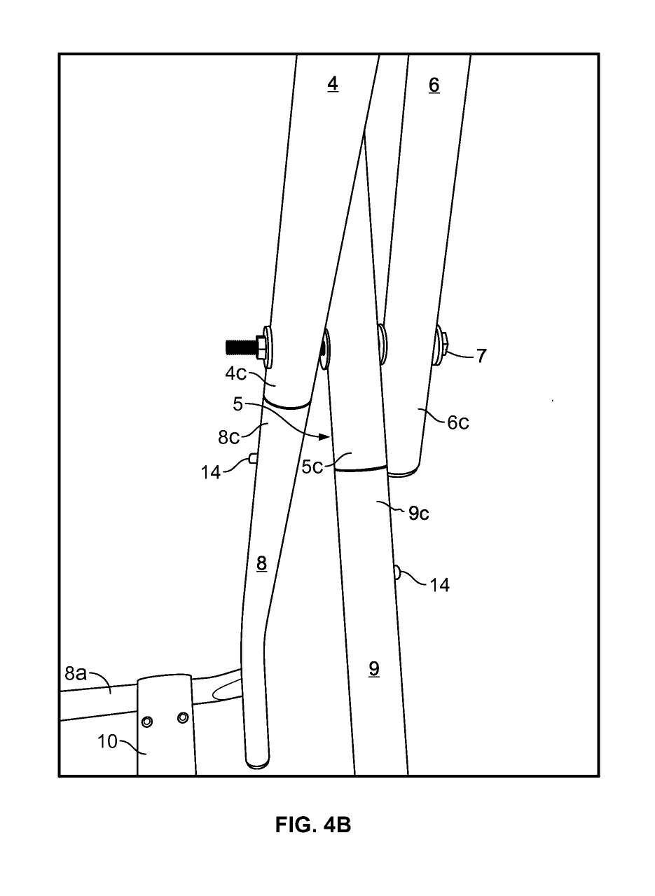

Referring to FIG. 1A, there is shown an exemplary collapsible saddle rack (1) in an open and unfolded configuration, fully assembled according to one embodiment of the invention. The saddle rack (1) generally comprises a collapsible upper portion (2) formed to support at least one saddle and a collapsible lower portion (3) removably attachable to the upper portion (2) for supporting the upper portion (2) in a desired elevated position above the ground.

Referring also to the other figures, the saddle stand upper portion (2) generally comprises two outer support members (4), (5) and a central support member (6) for supporting the desired saddle (not shown). In this particular embodiment, each of the support members (4, 5, 6) is a generally inverted u-shaped member. For example, outer member (4) is shown as an inverted u-shaped member comprising an upper base section (4a) connecting two opposed downwardly extending side sections (4b) that are shown substantially parallel to each other and substantially perpendicular to the base section (4a), each side section terminating at an end (4c). Similarly, for example, outer member (5) is shown as an inverted u-shaped member comprising an upper base section (5a) connecting two opposed downwardly extending side sections (5b) that are shown substantially parallel to each other and substantially perpendicular to the base section (5a), each side section terminating at an end (5c). The central support member (6) is shown as an inverted u-shaped member comprising an upper base section (6a) connecting two opposed downwardly extending side sections (6b) that are shown substantially parallel to each other and substantially perpendicular to the upper base section (6a), each side section terminating at an end (6c). The upper base (6a) of the central member (6) preferably has an upwardly extending contoured section (6d) at one end to mimic the contours of the underside of a saddle (not shown).

The upper support members (4, 5, 6) are pivotally connected to each other proximate their ends (4c, 5c, 6c) using a suitable connection, such as an axial bolt (7) as shown (preferably with washers therebetween). For example, in this embodiment the width of the upper base (4a) of member (4) is narrower to permit the respective outsides of side sections (4b) to be pivotally connected to the respective insides of side sections (5b). Similarly, in this embodiment the width of the upper base (6a) of member (6) is wider to permit the respective outsides of side sections (5b) to be pivotally connected to the respective insides of side sections (6b). The pivotal connection (7) permits the saddle stand upper section 2 to collapse inwardly so that the upper members (4, 5, 6) may be stored in a nested or near nested closed position. A flexible strap (20) is attached at its ends (20a) to the upper members (4a, 5a) and at its midpoint (20b) to upper member (6a). The length of the strap (20) serves to limit the distance that the upper members (4, 5, 6) may outwardly pivot when being moved towards the open position. The strap (20) may be made of a soft material such as leather, Rexene style of leather cloth, synthetic materials, nylon, vinyl, polypropylene, textiles, canvas, mesh, wirecloth, cloth etc. to enable folding of the upper portion (2) easily while being collapsed.

The saddle stand lower portion (3) generally comprises two leg support members (8, 9) for supporting the saddle stand upper section (2). In this particular embodiment, each of the leg support members (8, 9) is a generally u-shaped member. For example, leg member (8) is shown as a U-shaped, or H-shaped member comprising a lower base section (8a) connecting two opposed legs (8b) that are shown substantially parallel to each other and substantially perpendicular to the base section (8a), each opposed leg (8b) having an upper end (8c) for removably connecting to a corresponding one of the side section ends (4c) of the upper member (4), and a lower end (8d) for engaging a surface, such as the ground. Similarly, for example, leg member (9) is shown as a U-shaped, or H-shaped member comprising a lower base section (9a) connecting two opposed legs (9b) that are shown substantially parallel to each other and substantially perpendicular to the base section (9a), each opposed leg (9b) having an upper end (9c) for removably connecting to a corresponding one of the side section ends (5c) of the upper member (5), and a lower end (9d) for engaging a surface, such as the ground.

Additionally, if desired, one or more flexible bands or straps (10) may be connected between the lower base sections (8a, 9a) of the saddle rack lower leg members (8, 9). When in the open position (as shown) the bands create a shelf (11). Although the shelf (11) is shown here comprising a plurality of flexible bands (10), a shelf (11) could also be constructed by a flexible sheet (not shown) connected between the lower base sections (8a, 9a). The shelf or basket (11) could also be a removable rigid shelf member that extends between lower base sections (8a, 9a) or could be attached to one of the lower base sections (8a, 9a) in a hinged fashion to permit the lower section to be collapsed. Further, if desired for additional support, the lower base sections (8a, 9a) could employ additional support legs (8e, 9e).

Where the saddle rack is formed of hollow material, such as plastic or metal, suitable end caps or feet (13) may be employed to cover the opening.

The legs (8b, 9b) on the lower portion (3) are removably attached to the lower ends (4c, 5c) of the upper portion (2) support members (4, 5) through suitable connectors. Preferably, the connectors are of a quick connect, quick disconnect variety and are configured to firmly connect the legs (8b, 9b) to the upper portion (2) to prevent the removal of the legs (8b, 9b) from the upper portion (2) during use to maintain the structural integrity of the saddle rack (1) until disassembly is desired for transportation or storage. The upper portion (2) and lower portion (3) may be manufactured from materials such as wood, metal, plastic and the like and having cross section of any geometry with sufficient beam strength.

FIG. 1B is a perspective view of the collapsible saddle rack (1) of FIG. 1A shown here with the upper section (2) detached from the lower section (3), according to one embodiment of the invention. The upper and lower sections are connectable together using any number of suitable connectors to permit ready connection and disconnection. In this particular embodiment, the ends (4c) of each side section (4b) of the upper support member (4) further comprise male extensions (4d) (here shown as tubular in shape) for insertion into a corresponding slot (or tubular end) (8f) of the upper ends (8c) of legs (8b). The extension (4d) may be locked into place within the slot (8f) by suitable mechanisms, such as, pins, clamps, collars, flanges, interference fit, and the like. In this embodiment, a spring (14a) loaded pin (14) may be mounted within extension (4d) (e.g., in interior 4e) so that it may pop into place through receiving aperture 15 in the corresponding slot (8f) to lock the two members (4c, 8c) together. Similarly, the ends (5c) of each side section (5b) of the upper support member (5) further comprise male extensions (5d) (here shown as tubular in shape) for insertion into a corresponding slot (or tubular end) (9f) of the upper ends (9c) of legs (9b). The extension (5d) may be locked into place within the slot (9f) by suitable mechanisms, such as, pins, clamps, collars, and the like. A spring (14a) loaded pin (14) may be mounted within extension (5d) (e.g., in interior 5e) so that it may pop into place through receiving aperture 15 in the corresponding slot (9f) to lock the two members (5c, 9c) together.

Although the embodiment of FIG. 1A and FIG. 1B illustrates that the saddle stand lower portion (3) generally comprises two leg support members (8, 9) for supporting the saddle stand upper section (2), where each of the leg support members (8, 9) is a generally u-shaped member, it will be understood that the saddle stand lower portion (3) could also comprise a plurality of leg members (8b, 9b) that attach to upper section (2). For example, leg members (8b) could have an upper end (8c) that attaches to the lower end (4c) of upper member 4, and a lower end 8d that that contacts the ground. Similarly, leg members (9b) could have an upper end (9c) that attaches to the lower end (5c) of upper member 5, and a lower end 9d that that contacts the ground. The leg members (8b, 9b) could be independent of each other. If desired, the lower ends of the legs could be outfitted with attachment connectors to receive shelf or basket structure 11 to mount therebetween.

In another embodiment, the saddle rack (1) may be provided with a basket (11) at the lower portion (3) which serves the dual purpose of preventing the disassembling of the legs (8b, 9b) upon being detached from the upper portion (2) and also provides a means to store some utility items while in use. The basket (11) may be attached to the legs (8b, 9b) using two parallel horizontal pipes (8a, 9a) as shown in the figure. The basket (11) may be made of a soft material such as leather, Rexene style of leather cloth, synthetic materials, nylon, vinyl, polypropylene, textiles, canvas, mesh, wirecloth, cloth etc. to enable folding of the lower portion (3) easily while being collapsed.

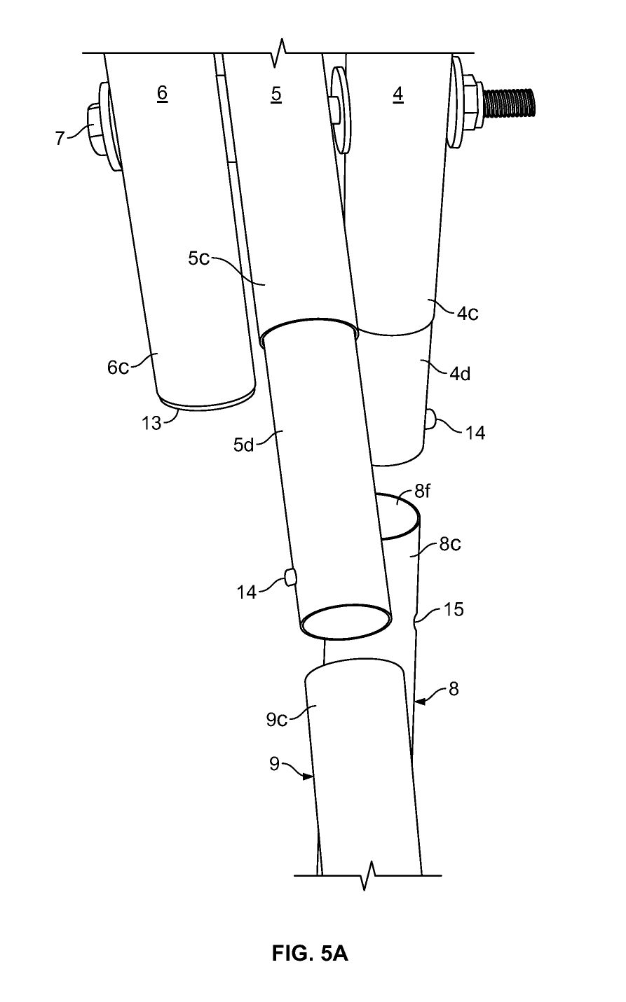

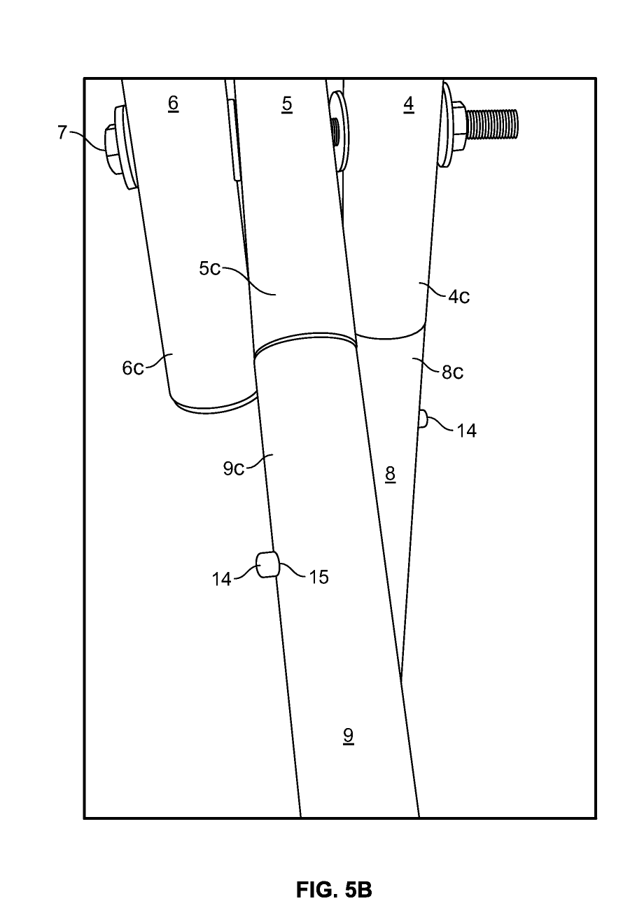

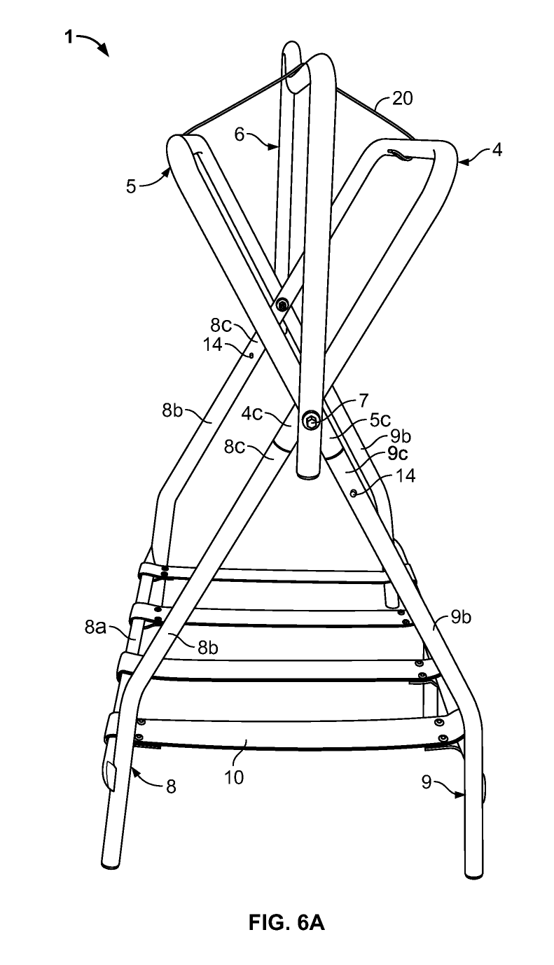

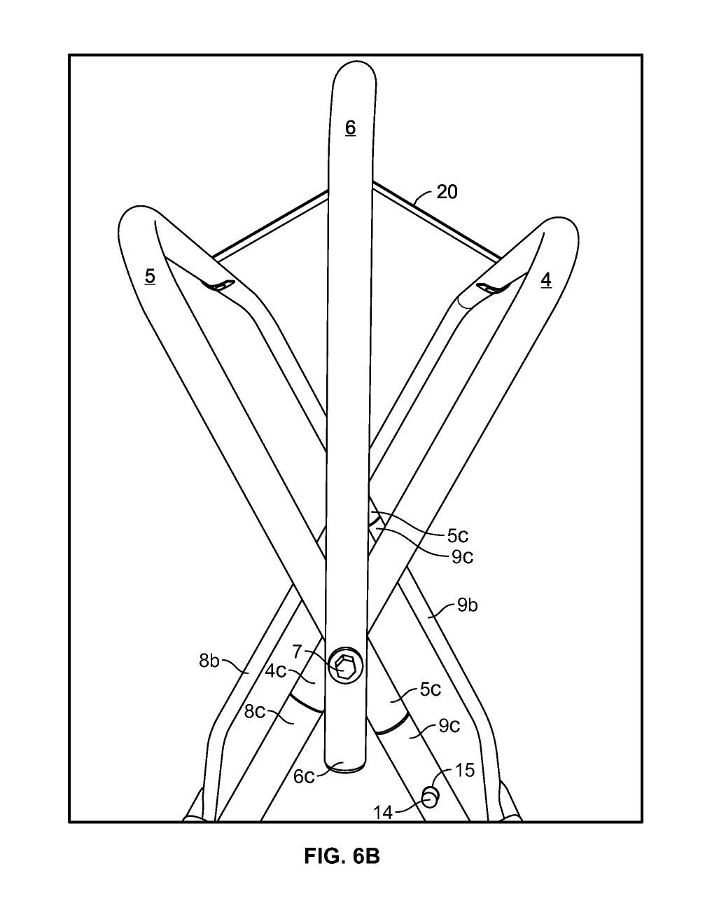

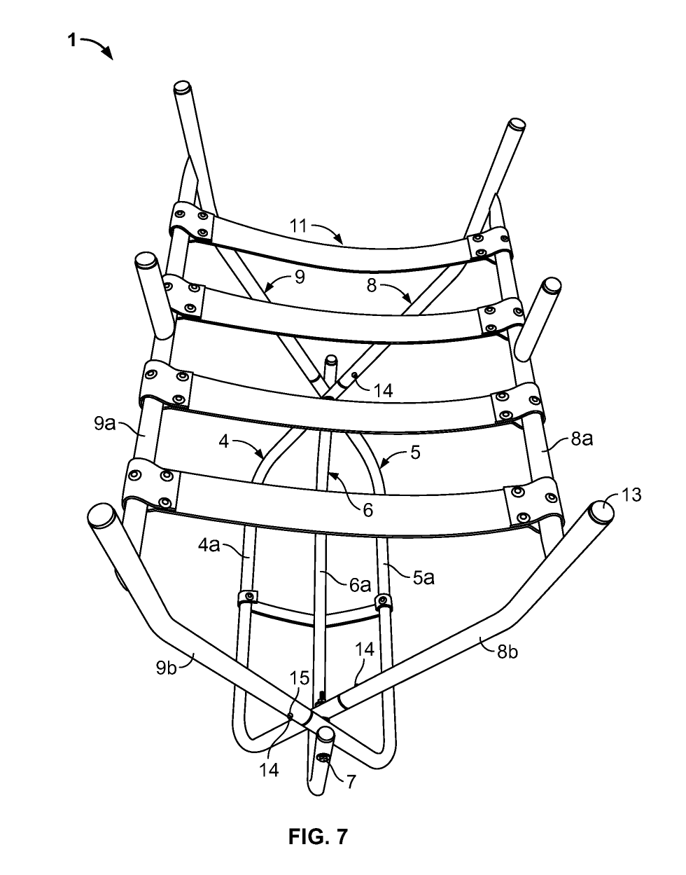

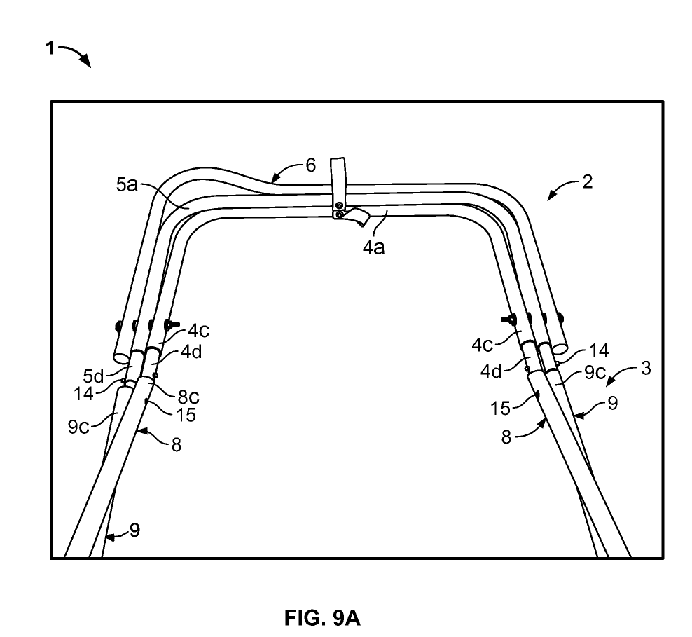

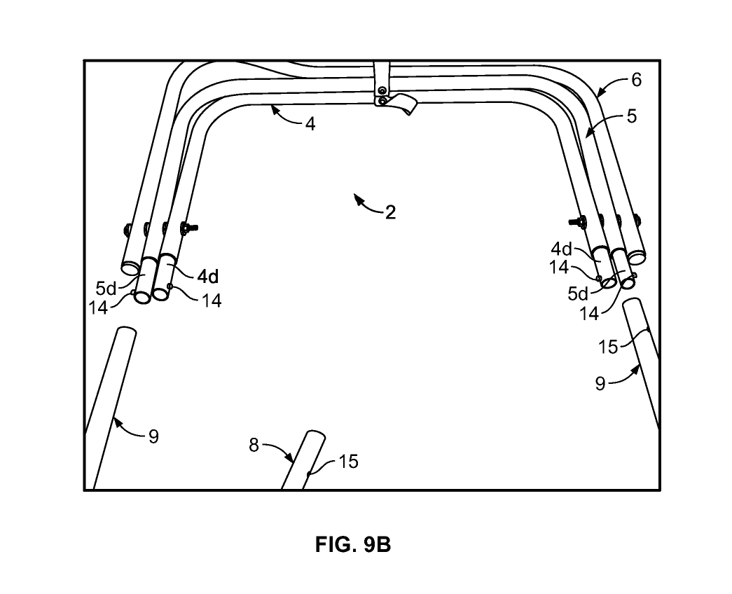

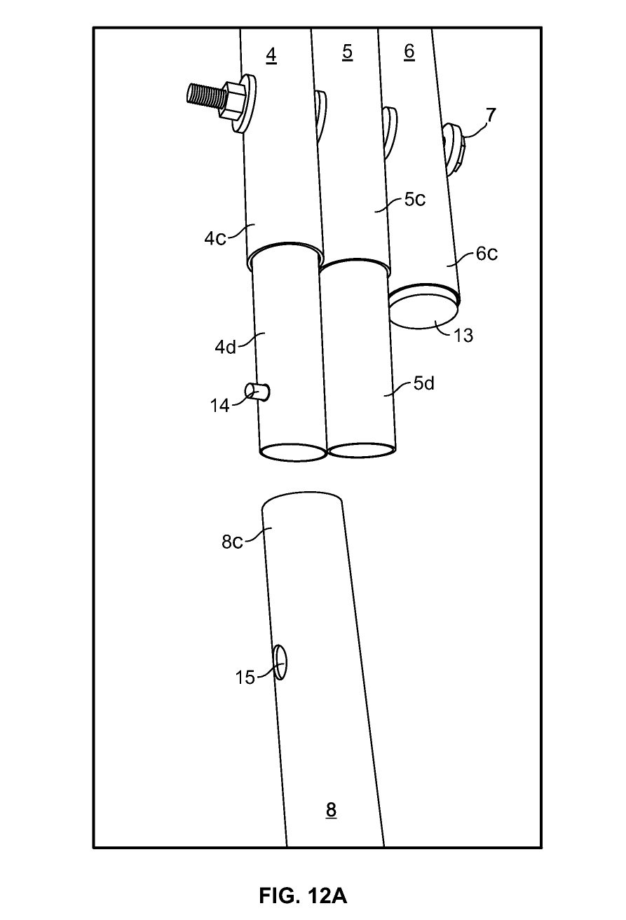

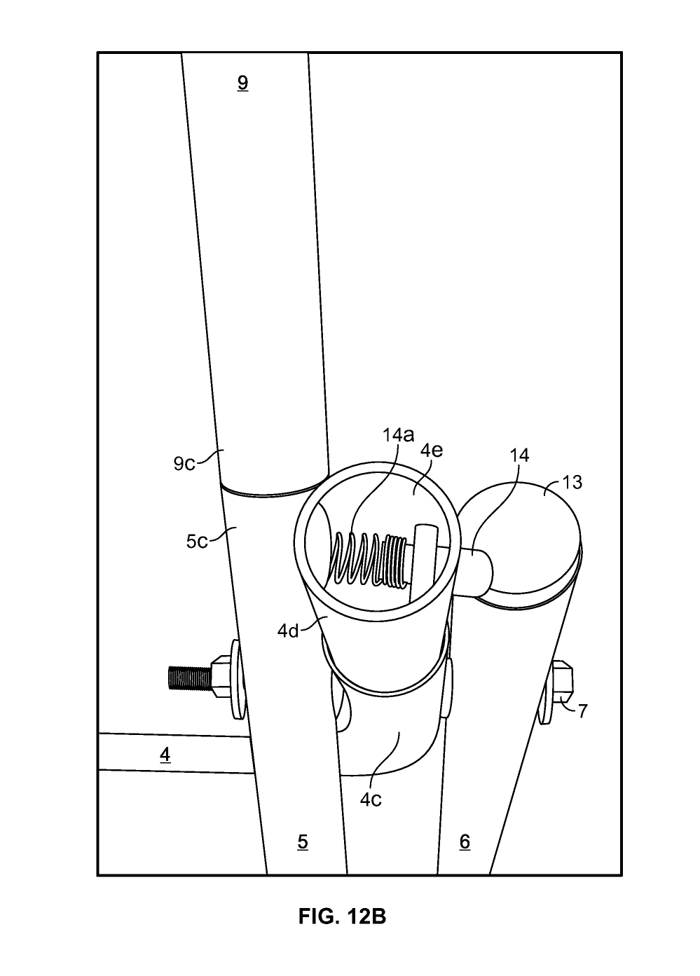

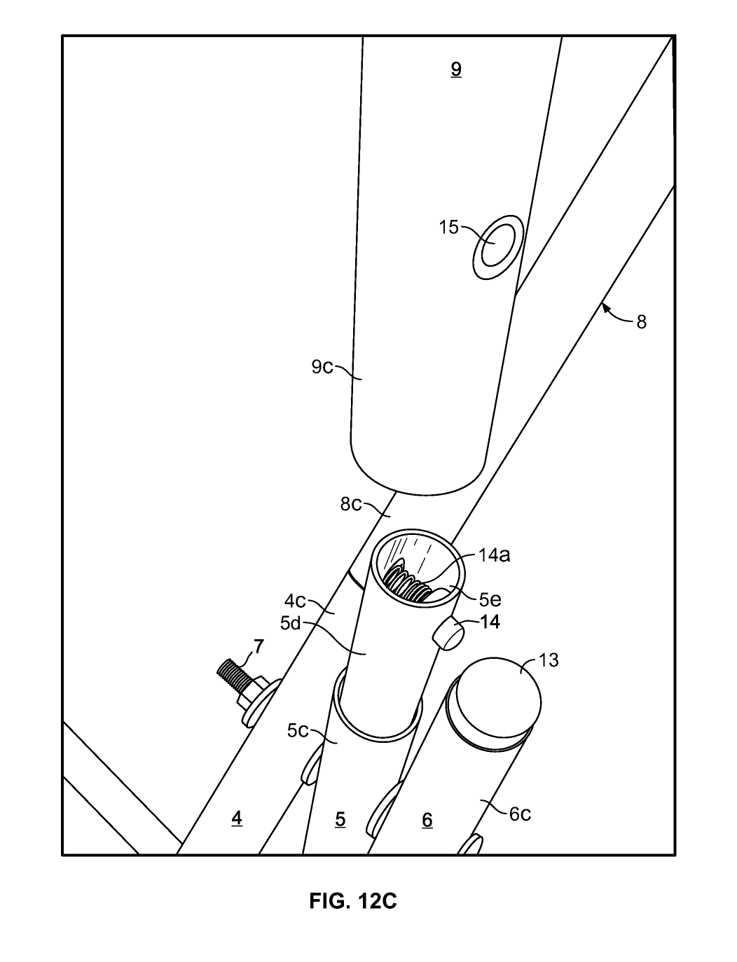

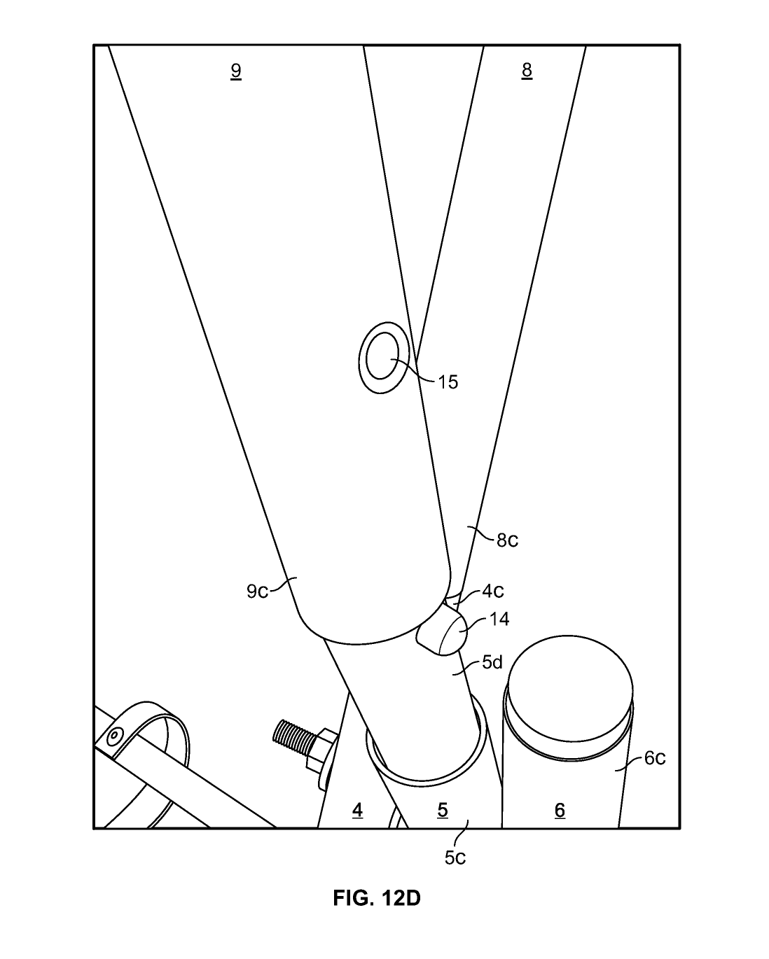

Referring now to, e.g., FIGS. 5A, 5B, 8C, 9A, 9B, 10, 11, 12A-12D, there is illustrated an exemplary connector mechanism used in collapsible saddle rack, according to one embodiment of the invention. In one embodiment, for example, the connector mainly comprises extended portions (4d, 5d) provided on the lower ends of the upper portion (2) which may be inserted firmly inside the slots (8f, 9f) provided on the top part of the legs (8, 9). Each slot (8f, 9f) comprises a hollow member with an aperture of suitable configuration to receive the extended portion (4d, 5d). In this embodiment, the extended portions (4d, 5d) may have commonly available spring loaded push-pins (14) attached on their distal end to firmly lock the extended portions (4d, 5d) inside the hole (15) provided on the slot (8f, 9f). While attaching the legs to the upper portion, the spring loaded push-pins (15) on the extended portions (4d, 5d) may be pressed and pushed inside the slots (8f, 9f) in such as way the spring loaded push-pins (14) reach the hole (15) provided on the slot (8f, 9f) and the spring loaded push-pins (14) fits properly inside the hole (15) and is locked. Once the extended portion (4d, 5d) is locked inside the slot (8f, 9f), the connection is established and provides a firm support to the saddle rack during use. To disassemble, the push-pin (14) can again be pushed to disengage it from the aperture (15), and the upper and lower portions (2, 3) can be separated, and collapsed for transport or storage.

Those having the benefit of the present disclosure will understand that there are other suitable technologies for connecting the upper and lower sections (2, 3) in a manner that permits quick connect, and quick disconnect while also providing a firm connection to provide stability to the saddle rack (1).

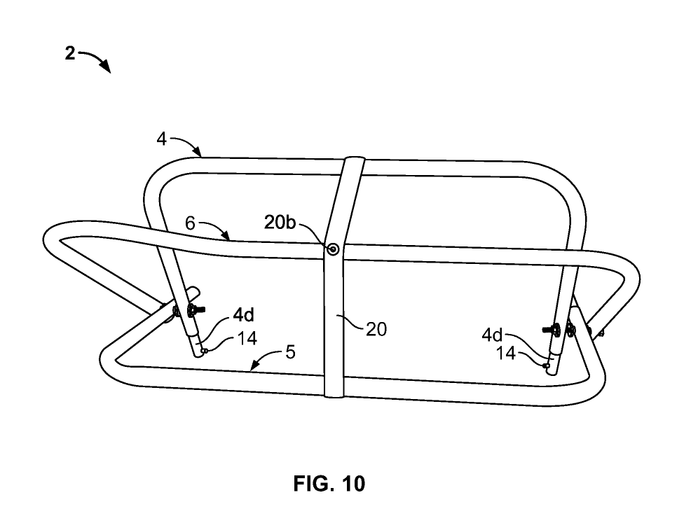

FIG. 10 is a perspective view of the detached upper portion (2) of the collapsible saddle rack (1), according to one embodiment of the invention. The upper portion (2) of the saddle rack (1) may be detached easily from the lower portion (3) by pressing the spring loaded push-pins (14) (or other connector) provided on the extended portions (4d, 5d) and then by pulling the upper portion (2) upwards. Once disassembled, the top portion (1) may be collapsed separately and stored easily.

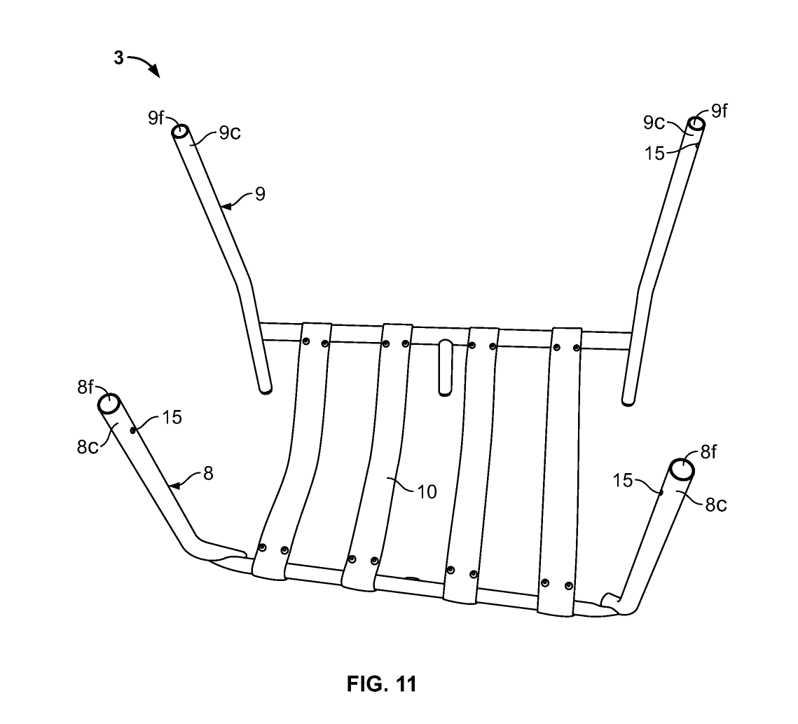

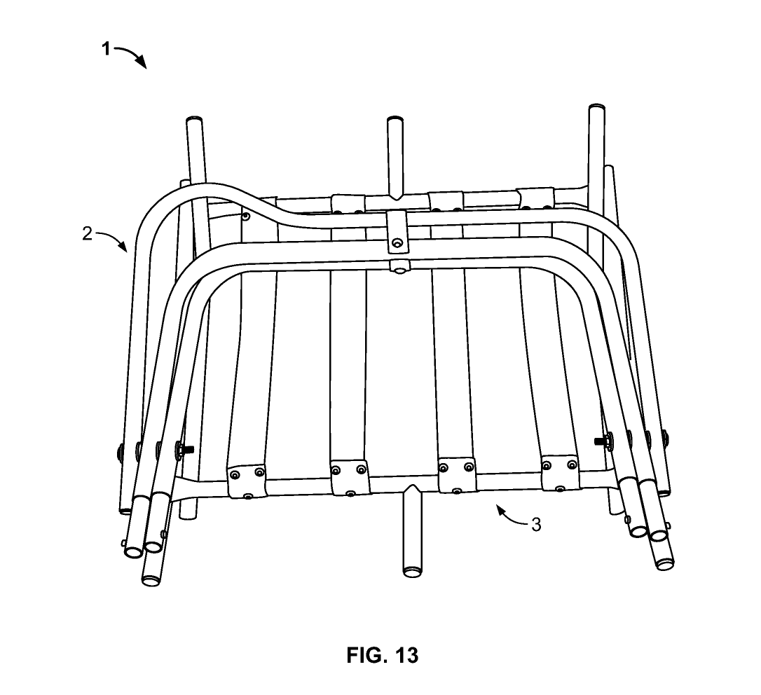

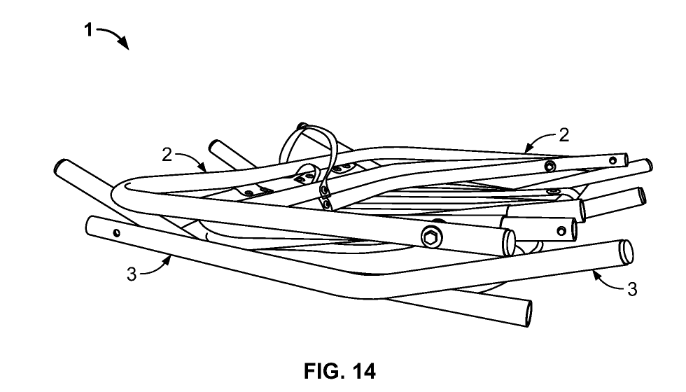

FIG. 11 is a perspective view of the detached lower portion (3) of the collapsible saddle rack (1), according to one embodiment of the invention. As shown in the figure, the lower portion (3) is detached from the upper portion (2) of the saddle rack (1). The legs (8b, 9b) of the lower portion (3) may be joined together through the basket (10) which serves the dual purpose of preventing the disassembling of the legs (8b, 9b) upon being detached from the upper portion (1) and also provides a storage place keep some utility items while in use. Since the basket (11) is preferably made of flexible material, the lower portion (3) may be easily collapsed. Given that the upper portion (2) and lower portion (3) can be detached and collapsed separately, the saddle rack (1) occupies the least space in collapsed configuration (see FIGS. 13-14) permitting easy shipping and storage.

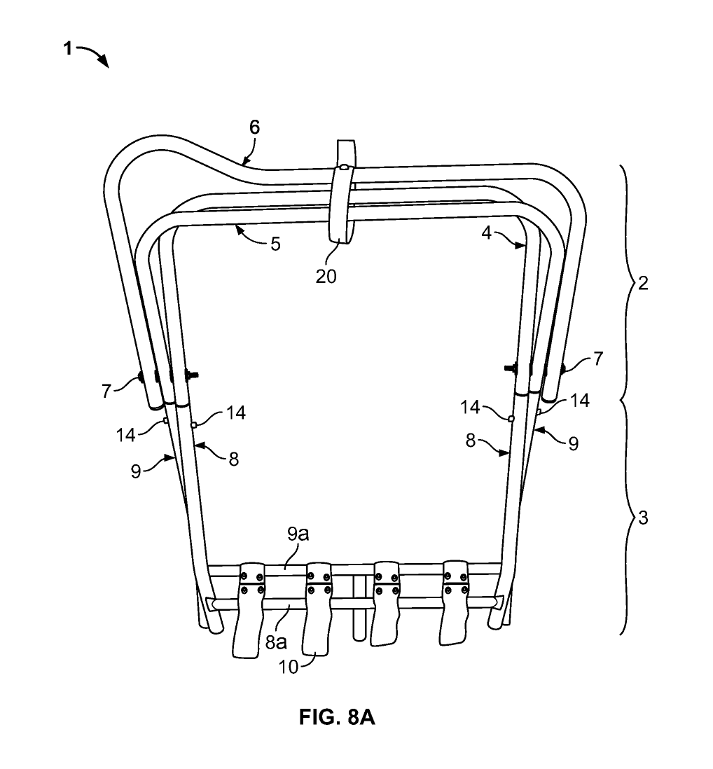

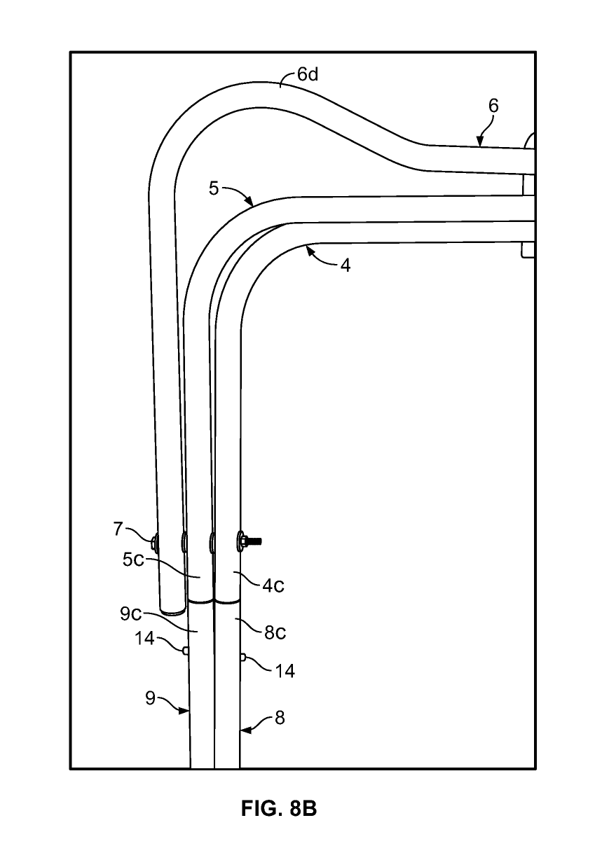

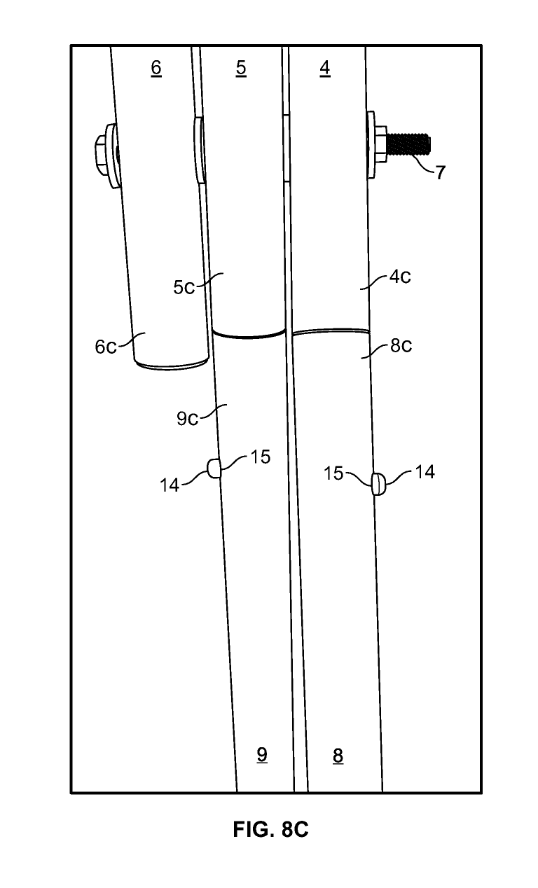

FIG. 8A is a perspective view of a collapsible saddle rack (1) in collapsed position, according to one embodiment of the invention. The saddle rack (1) may be collapsed in attached configuration (where upper and lower sections 2, 3 are attached together) as well since the connecting mechanism is provided below the axis of rotation of the saddle rack assembly.

FIG. 13 shows the top view of the collapsed upper portion (2) of the collapsible saddle rack (1) placed above the collapsed legs portion (3), according to one embodiment of the invention. In this embodiment, both, the upper portion (2) and the lower portion (3) are in collapsed configuration and are disposed one above the other. Since the saddle rack (1) occupies the least space in folded or collapsed configuration, it provides more portability and ease of transportation of the saddle rack (1) from one place to another. In this configuration, the upper and lower sections (2, 3) could be stored in a canvas bag or other suitable container as may be desired.

FIG. 14 shows the perspective view of the collapsed upper portion (2) of the collapsible saddle rack (1) placed above the collapsed legs portion (3), according to one embodiment of the invention. The saddle rack (1) according to the invention enables easy transportation and compact storage due to easy assembling/disassembling and collapsible functionalities. Since the legs (8, 9) are not completely disassembled while being detached from the upper portion (2), it becomes easier to re-assemble and manage the whole assembly. The saddle rack (1) according to the present invention is light weight, inexpensive and easy to manufacture. The compactness and collapsibility of the present invention also permits shipment in a smaller container, thereby providing significant cost savings on shipping. When a consumer receives the saddle rack via its compact form of shipment, or when the consumer takes the disassembled, and collapsed saddle rack out of storage, the consumer or end user can easily assemble or reassemble the saddle rack using the quick connect and quick disconnect connections.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed. For example, although push-pin connectors (14, 15) have been described for use in connecting the upper and lower sections (2, 3) together, other connectors can be employed, preferably those that are of the quick connect, quick disconnect variety. Also, although the present saddle stand invention generally depicts an upper framework for holding a Western style saddle, it will be understood by those having the benefit of the present disclosure that the shapes of the upper support members (4, 5, 6) could be altered to provide a different overall outer support profile to serve as a saddle stand for other types of saddles (e.g., English, Western, Australian, etc.). Other suitable saddle stands could be configured based on the teachings of the instant application to provide the desired compactness.

All references referred to herein are incorporated herein by reference. While the of this invention has been described in terms of preferred embodiments, it will be apparent to those of skill in the art that variations may be applied to the device described herein without departing from the concept and scope of the invention. All such similar substitutes and modifications apparent to those skilled in the art are deemed to be within the scope and concept of the invention. Those skilled in the art will recognize that the apparatus of the present invention has many applications, and that the present invention is not limited to the representative examples disclosed herein. Moreover, the scope of the present invention covers conventionally known variations and modifications to the system components described herein, as would be known by those skilled in the art. While the apparatus and methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

I claim:

1. A saddle rack comprising:
a. an upper portion formed to support at least one saddle wherein the upper portion is collapsible;
b. a lower portion comprising plurality of legs removably connected to the upper portion of the saddle rack wherein the lower portion is collapsible; and
c. a connector for removably attaching the legs to the upper portion;
wherein the upper portion and lower portion occupy the least space in the collapsed configuration.

2. The saddle rack as claimed in claim 1 wherein the connector is configured to firmly connect the legs to the upper portion to prevent the removal of the legs from the upper portion during use and to provide stability to the saddle rack.

3. The saddle rack as claimed in claim 1 wherein the lower portion further includes a basket attached at the lower end of the lower portion to prevent the disassembling of the legs upon being detached from the upper portion.

4. The saddle rack as claimed in claim 3 wherein the basket is made of a soft material to enable folding of the lower portion easily while being collapsed.

5. A collapsible saddle rack comprising:
a. an upper portion formed to support at least one saddle wherein the upper portion is collapsible, the upper portion comprising a plurality of inverted U-shaped tubes each having a substantially horizontal base section and two opposed, downwardly extending side members, each side member having an end;
b. a collapsible lower portion removably connected to the upper portion of the saddle rack, the lower portion comprising a plurality of legs each having a bottom end for contacting a desired surface and a top end removably connected to the respective end of each of said side members; and
c. a connector for removably attaching the legs to the upper portion;
wherein the upper portion and lower portion occupy the least space in collapsed configuration, and wherein the upper portion is capable of being placed in an open position for receiving the saddle, or a collapsed position for storage of the saddle rack.

6. The collapsible saddle rack of claim 5 wherein the connector further comprises:
(i) extension members on the ends of the downwardly extending side members, and
receiving members in the top ends of each of the plurality of legs for receiving said extension members.

7. The collapsible saddle rack of claim 6 wherein the connector further comprises:
(iii) a spring loaded push-pin located on each of the extension members, and
(iv) an aperture located in the receiving members for receiving the push-pin so that the extension member is locked into place within the receiving member when the push pin is received into the aperture.

8. The collapsible saddle rack of claim 5 wherein the plurality of inverted U-shaped tubes in the upper member are configured to provide an outer profile suitable for receiving a Western style saddle when the saddle rack is in not collapsed.

9. The collapsible saddle rack of claim 5 wherein the plurality of inverted U-shaped tubes are pivotally connected to each other proximate their ends.

10. The collapsible saddle rack of claim 5 wherein the plurality of inverted U-shaped tubes further comprises a central inverted U-shaped tube flanked on either side by two outside U-shaped tubes, the ends of the central tube and the two outside tubes being joined together with a horizontally axially-oriented bolt to permit the outside tubes to rotate inwardly or outwardly about said axis relative to the central tube or each other.

11. The collapsible saddle rack of claim 10 wherein the collapsible lower portion comprises individual leg members that are removably attachable to a corresponding end of the inverted U-shaped tubes of the upper section.

12. The collapsible saddle rack of claim 10 wherein the collapsible lower portion comprises two U-shaped members each comprising a lower base section connecting two opposed legs that are aligned substantially parallel to each other and substantially perpendicular to the base section, each opposed leg having an upper end for removably connecting to a corresponding one of the ends of upper section outside tubes, and a lower end for engaging a surface supporting the saddle stand.

13. The collapsible saddle rack of claim 12 further comprising a plurality of flexible straps are mounted between the based section of each of the two U-shaped members.

14. The collapsible saddle rack of claim 10 further comprising a flexible strap connecting between the central inverted U-shaped tube and the two outside U-shaped tubes to provide a physical stop to prevent further opening of the saddle stand upper portion about the axially-oriented bolt.
